(19) United States
(12) Patent Application Publication
(10) Pub. No.: US 2021/0039456 A1
(43) Pub. Date: Feb. 11, 2021

(54) EXTERNAL TENSIONING ANTI-SKID CHAIN FOR AN AUTOMOBILE

(71) Applicant: Le Zhuang, Nanjing City (CN)

(72) Inventor: Le Zhuang, Nanjing City (CN)

(73) Assignee: Le Zhuang, Nanjing City (CN)

(21) Appl. No.: 17/078,485

(22) Filed: Oct. 23, 2020

Related U.S. Application Data
(63) Continuation-in-part of application No. PCT/CN2019/075093, filed on Feb. 14, 2019.

(30) Foreign Application Priority Data
Apr. 28, 2018 (CN) 201810399703.4

(51) Int. Cl. B60C 27/10; B60C 27/06

(52) U.S. Cl. CPC B60C 27/10; B60C 27/068; B60C 27/066

(57) ABSTRACT

An external tensioning anti-skid chain system for an automobile, whose characteristics include a number of U-shaped anti-skid boards with the same structure and a set of tightening mechanisms. The two vertical edges of the U-shaped anti-skid plate are attached to the inside and outside of a tire. The first section and the last section of the U-shaped anti-skid plate are connected by a buckle structure. The tightening mechanism is installed between two adjacent U-shaped anti-skateboards, and the U-shaped anti-skid plates are mutually connected by connection rings. The anti-skid chain system has a simple structure, making installation and disassembly very easy.

### CROSS REFERENCE TO RELATED APPLICATIONS

The present application claims priority to International Patent Application Serial No. PCT/CN2019/075093 filed 14 Feb. 2019, and to Chinese Patent Application Serial No. 201810399703.4 filed 28 Apr. 2018, both of which are hereby incorporated by reference in their entirety.

### BACKGROUND OF THE INVENTION

### Field of the Invention

The invention relates to an automobile technology, in particular to an automobile anti-skid technology. Specifically, it is an external (including crankshaft and wire rope) anti-skid chain of an automobile which can be tensioned on the outside of the vehicle without having to extend the hand to the inside of the tire for operation.

### Description of Related Art

As we all know, ordinary road surface is most suitable for tires. If the road surface is frozen, the adhesion of car tires to the ice must be greatly reduced. Serious problems will occur in the effective output of engine power, the maneuverability of automobile direction, and the effectiveness of braking. This will not only reduce transport efficiency, resulting in traffic paralysis, and often lead to the tragic loss of life.

In order to deal with this problem, people have designed different types of automotive skid chains. There are many kinds of anti-skid chains, but they generally have one common weakness: inconvenience. Even for young and strong professional drivers, installing and removing anti-skid chains is not a simple or easy task. For the large number of family car users, especially the elderly and young ladies among them, it is even more difficult to cope with.

The serious inconvenience of installation and disassembly of automobile anti-skid chain objectively leads to a rather negative reality. Many people do not buy skid chains at all. Some people have purchased the anti-skid chain, but do not install and use it timely. Some people want to install the chain when the road is frozen, but they are unable to do it. Some manufacturers, aiming to reduce the difficulty of installation, deliberately increase adjacent anti-skid chain distribution distance, so that the tire often directly contact with the ice in the absence of the participation of anti-skid strip. In this case, it is extremely easy to lose control when in need of accurate control of the direction and effective braking. That is to say, the inconvenience of installation and disassembly of automobile anti-skid chain greatly restricts the normal function of anti-skid chain. It is necessary to correct this negative situation thoroughly.

### SUMMARY OF THE INVENTION

The purpose of the present invention is to design a kind of external tensioning anti-skid chain of automobile which is especially convenient for installation and disassembly, aiming at solving the problems that the existing anti-skid chain of automobile is inconvenient for installation, causing low efficiency in use, and causing safety hidden trouble for driving on frozen snow road.

The first technical solution of the present invention is elaborated below.

An external tensioning anti-skid chain for an automobile, whose characteristics include that it comprises a number of U-shaped anti-skid boards 1 with the same structure and a set of tightening mechanism. The two vertical edges of the U-shaped anti-skid plate 1 are attached to the inside and outside of the tire. The first section and the last section of the U-shaped anti-skid plate 1 are connected by a buckle structure. The tightening mechanism is installed between two adjacent U-shaped anti-skateboards 1, and the U-shaped anti-skid plates 1 are mutually connected by connection rings 3.

The buckle structure is composed of hook plate 4 with holes connected to both vertical sides of the last (tail section) U-type anti-skid plate 1 and hook 5 on both vertical sides of the first (head section) U-type anti-skid plate 1. The hook 5 is hooked into the hole on the corresponding hook plate 4 with holes. The two vertical sides of the U-shaped anti-skid plate 1 are curved inward so as to tighten and hold the tire firmly on both sides.

The length of the hook plate 5 is adjustable. It is designed based on the outsider diameter of new tires. The thread at the root can be properly screwed and adjusted, to adapt to different abrasion conditions of the old tire installation needs.

The bottom of the U-shaped anti-skid plate 1 in contact with the ground has a “chevron pointing” character grain structure, in order to increase the pressure on the ice surface and to enhance the anti-skid effect.

A manual screw plate 6 for mounting and positioning is connected to the outer vertical side of one or two U-shaped anti-skid boards 1. This manual screw plate 6 is preferably mounted on the U-shaped anti-skid plate in positions corresponding to the four-o'clock and the eight-o'clock positions on the tire.

The tightening mechanism is a crankshaft tightening mechanism. This crankshaft tightening mechanism comprises a crankshaft 2 and an operating handle 9. The main shaft of the crankshaft 2 pivots on a mounting plate 7 attached to a U-shaped anti-skid plate 1. The crank part of the crankshaft 2 can be inserted into the crank sleeve 8 connected to the adjacent U-shaped anti-skid plate 1. The outer spindle of the crankshaft 2 is connected with an operating handle 9. A stability card 10 is arranged on the vertical side of the U-shaped anti-skid plate 1 of the mounting shaft of the crankshaft 2. When the handle 9 attached to the crank is turned 180 degrees, the distance between the U-shaped slide 1 mounted with the crankshaft and the U-shaped slide 1 connected with the crankshaft bushing 8 shrinks, and the hook plate 4 hooks tightly with hole and hook 5, and the whole chain is fastened to the tire. The operating handle 9 is positioned on the vertical side of U-shaped anti-skid plate 1 under the constraint of stability card 10. Loosening the stability card 10 and reversing the operating handle can restore the crankshaft to its original state. The distance between two adjacent U-shaped anti-skid plates 1 increases, and the hook 5 can come out of the hook plate 4 with holes. By loosening the manual screw plate 6, the anti-slip chain slides off the ground due to its own weight. By moving the car forward or backward, the chain can be taken out for re-use.

The crank sleeve 8 is connected to a U-shaped anti-skid plate 1 through a polyurethane connector. The two vertical sides of the U-shaped anti-skid plate 1 are in a cruciform structure, and the connecting rings are in tight position.

The outer spindle of the crankshaft 2 is flanged with the operating handle 9 through a universal joint.

The tightening mechanism is a steel-wire-rope tightening mechanism. One end of the wire rope 11 is attached to the bottom edge of a U-shaped anti-skid plate, and then enters the guide slot 12 of the adjacent U-shaped anti-skateboard, and then passes through the bottom edge of the two adjacent U-shaped anti-skateboard in an S-shape, and then enters the guide ring 13 on a U-shaped anti-skateboard, and finally wounds on the ratchet 14. Turning the ratchet 14 can tighten the wire rope. Loosening the pawl 15 can reversely loosen the wire rope.

The hook plate 4 with holes and the hook 5 are installed on the vertical side of U-shaped anti-slide plate 1.

The mounting plate 7 and the crank sleeve 8 are connected with the bottom edge of U-shaped anti-skid plate 1.

The second technical solution of the present invention is elaborated below.

It comprises a number of U-shaped anti-skid plates 1 of the same structure and a set of wire rope tightening mechanisms 16. The two vertical edges of the U-shaped anti-skid plate 1 are attached to the inside and outside of the tire. The first section and the last section of the U-shaped anti-skid plate 1 are connected by the wire rope tightening mechanism 16. A manual screw plate 6 for mounting and positioning is connected to the outer vertical side of one or two U-shaped anti-skid boards 1. The wire rope tightening mechanism 16 is composed of a wire rope 11, a ratchet wheel 14 and a pawl 15. One end of the wire rope 11 is fixed to the inside bottom edge of the U-shaped anti-skid plate 1. The other end is connected to the ratchet 14 by bypassing the guide slot 12 on the adjacent U-shaped anti-skid plate 1. Turning the ratchet 14 can tighten the wire rope 11. When releasing the pawl 15, the ratchet 14 can turn in the reverse direction, and the wire rope is loosened and released from the guide groove 12, and the anti-skid chain can be removed from the tire.

Beneficial effects of the present invention are elaborated below.

Firstly, the present invention is a complete system of its own. It has no loose accessories, nor does it require additional tool support. Therefore, it will never lose accessories or lack of appropriate tools in practical use, and hence it has extremely high reliability.

Secondly, the actual installation of the existing automobile anti-skid chain is a random binding, the binding effect varies from person to person and cannot be strictly standardized. The installation of the invention is a rigorous assembly, and the results of installation by any person is highly standardized and unified, completely eliminating the risk of accidents.

Thirdly, the installation of the present invention is completely independent of the automobile wheel hub, and there is no problem of accelerating abrasion on the tire.

Fourthly, the present invention has at least one anti-slip chain in contact with the icy surface at any time when it is in use, which is extremely safe.

Fifthly, the perimeter of the present invention is designed according to the reasoning of a “new tire”. For the wires that have been worn out a lot, and the crankshaft type can ensure a good match of perimeter by “adjusting nut”. Wire rope type structure can directly tighten the ratchet.

Sixthly, the most obvious advantage of the present invention is that the installation is very easy and simple. Even for a person who is lack of mechanical knowledge, for an elderly or a lady who owns a private car, it is easy to master the way and practical operation. The installation operation of the present invention is carried out completely on the outside, which absolutely precludes the necessity of “inside operation”. Even in the night when the lighting is extremely poor, it is highly impossible to make mistake by hand operations.

Seventhly, we do not see any restriction factors on aspects of the design, manufacture, and economic cost. It is easier to promote to the society.

Eighthly, the installation and use of the present invention is particularly convenient, which can greatly improve the enthusiasm of drivers for timely installation and use. It overcomes the common social problems of not actively purchasing, not timely using, not actively using or not using the automobile anti-skid chain. This will be extremely beneficial to greatly reduce the traffic accidents on icy roads in winter and to reduce the unwarranted loss of life and property. This safety effect is the fundamental goal of the present invention.

The invention realizes toolless and outsider installation in the true sense, and the installer does not need to reach into the inside of the tire for operation, and does not need to carry any installation tools, so that disassembly and installation are easy and convenient.

### BRIEF DESCRIPTION OF THE DRAWINGS

FIG. 1 is the first schematic diagram of the expanded state structure of the present invention.

FIG. 2 is the second schematic diagram of the expanded state structure of the present invention.

FIG. 3 is the third schematic diagram of the expanded state structure of the present invention.

FIG. 4 is a three-dimensional structure diagram of a single U-shaped anti-skid plate in the present invention.

FIG. 5 is a schematic diagram of the initial installation state of an anti-slip chain in Implementation Example 1 of the present invention.

### DETAILED DESCRIPTION OF THE INVENTION

In the following we present a further explanation of the invention in conjunction with the appended drawings and implementation examples.

### Implementation Example 1

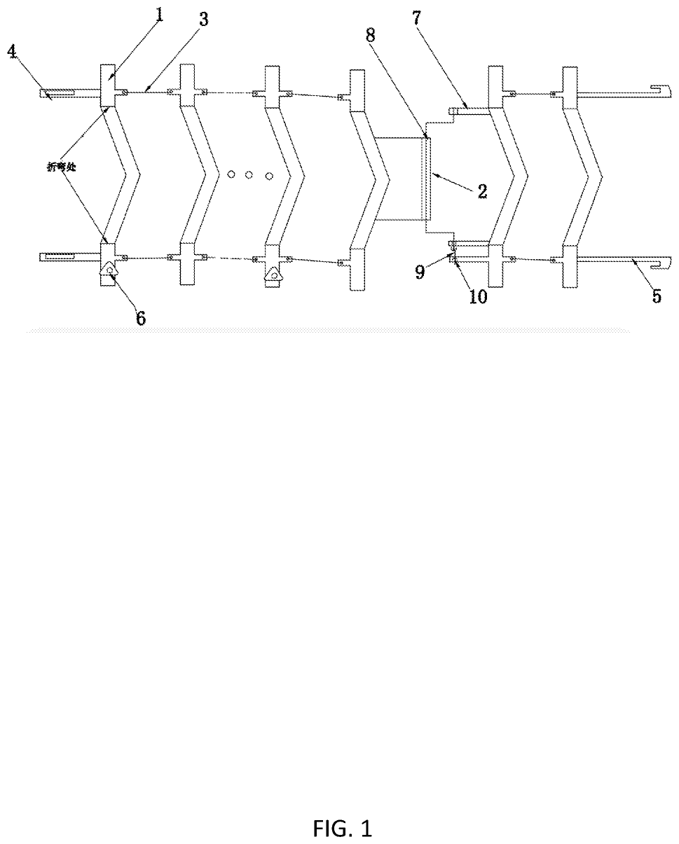

See FIGS. 1, 4, and 5.

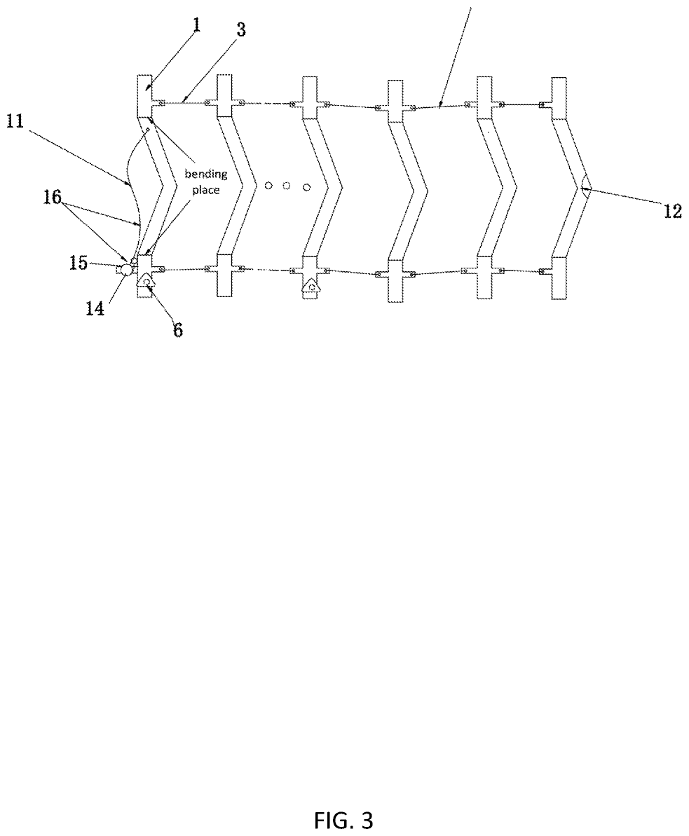

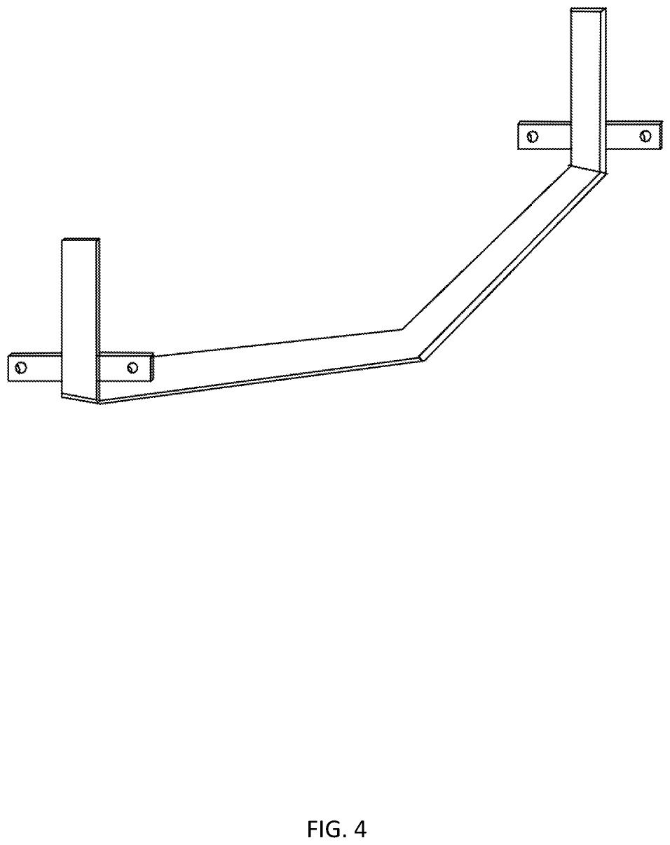

An external tensioning anti-skid chain for an automobile. It comprises a number of similar-structured U-shaped anti-skid boards 1 and the tightening mechanism shown in FIG. 4 (depending on the location, the main connector parts vary slightly). The tightening mechanism can be crank mechanism, wire rope tensioning mechanism or CAM locking mechanism. In the implementation example we use crank mechanism as an illustrate. The crank mechanism comprises a crankshaft 2 and an operating handle 9, shown in FIG. 1. The bottom of the U-shaped anti-skid plate 1 in contact with the ground shall preferably be designed with a “chevron pointing” character grain structure, while other non-slip pattern structure is also acceptable. The two vertical sides of U-shaped anti-skid board 1 are attached to the inside and outside of the tire. Except for one side of the first and last U-shaped anti-skid plate 1 and one side of the U-shaped anti-skid plate mounted with crankshaft 2 and the adjacent U-shaped anti-skid plate side, all u-shaped anti-skid plates are connected by connection rings 3. The installation positions of connection rings 3 are located on the vertical side of both sides of the U-shaped anti-skid plate 1. The two vertical sides of the U-shaped anti-skid plate 1 can be designed into a cross-shaped structure. The connecting rings connect the two sides of the cross. The last section (tail section) of U-type anti-skid plate 1 is connected with hook plate 4 with holes on both sides of vertical edges. The first section (head section) of U-type anti-skid plate 1 is connected with hook 5 on both vertical sides. Under implementation, the positions of hook plate 4 and hook 5 with holes can be swapped. The length of the hook plate 5 is best designed to be adjustable (bolt and screw sleeve structure can be adopted and adjusted according to the length of the screw-in), to adapt to different abrasion conditions of the old tire installation needs. Hook 5 is hooked into the holes on the corresponding hook plate 4 with holes. Under implementation, for installation convenience, there should be a manual screw plate 6 attached to the tail section and the lateral vertical side of some U-shaped anti-skateboard 1 in the middle (may be set in four o'clock and eight o'clock on U-shaped anti-skid plate, see FIG. 3). The initial positioning of anti-skid chain installation can be realized by tightening the manual screw plate 6. The spindle of the crankshaft 2 is pivots on one of the mounting plates 7 connected with the U-shaped anti-skid plate 1. The crank part of the crankshaft 2 can be inserted into the crank casing 8 connected to the adjacent U-shaped anti-skid plate 1. The outer spindle of crankshaft 2 is connected with the operating handle 9 through the universal joint. The operating handle 9 is positioned on the vertical side of the U-shaped anti-skid plate 1 for mounting the crankshaft 2 spindle, and a stability card 10 is used to prevent the crank of the crankshaft from freely turning. When handle 9 is operated to turn the crank 180 degrees, the distance between U-skid plate 1 mounted with crankshaft and U-skid plate 1 connected with crankshaft bushing 8 shrinks, and thus the hook plate 4 and hook 5 with holes are tightened, so that the whole chain is fastened to the tire. The operating handle 9 is positioned on the vertical side of u-shaped anti-skid plate 1 under the constraint of stability card 10. Loosening the stability card 10 and reversing the operating handle can restore the crankshaft to its original state, and the distance between two adjacent U-shaped anti-skid plates 1 increases, so that the hook 5 can be easily removed from the hook plate 4 with holes. Loosening the manual screw plate 6 makes the chain slide from the tire to the ground. Drive the car forward or backward, the anti-skid chain can be taken out for reuse.

In real implementation, in order to improve the U-shaped anti-skid plate 1 and tire fit, the two vertical sides of U-shaped anti-skid plate 1 are curved inward so that they can hold both sides of the tire after installation. The crank sleeve 8 is connected with the U-shaped anti-skid plate 1 through a polyurethane connector. The hook plate 4 and hook 5 with holes are preferably installed on the vertical side of U-shaped anti-slide plate 1 at the same position as the connection ring 3. The mounting plate 7 and the crank sleeve 8 are preferably mounted on the bottom edge of U-shaped anti-skid plate 1.

In real implementation, for convenient installation, the left and right sides of the anti-skid chain is best designed and manufactured symmetrically, so that a single move of the car can achieve the complete the installation of anti-skid chains on the four tires.

Elaboration in detail:

U-shaped anti-skid plate 1 is shaped like arthropod structure of a centipede. The anti-skid plate can be lined with thin rubber plate or polyurethane plate, to reduce abrasion on car tires. The two vertical sides of the U shape are equivalent to the claws of the centipede, holding both sides of the tire. The outside and the top is anti-slip structure, where the distance between the two anti-skid plates are about 80 mm, and forms chevron pointing pattern (see the attached figures, and this structural modeling is not the only form that cannot be replaced).

The connection ring 3 is symmetrically arranged on the side of the anti-skid plate, using metal rings. Its function is to reliably connect the front and rear two anti-skid plates, allowing each to move up and down asynchronously within a certain range.

Anti-skid tail section is characterized by the following. Each side of the vertical side has a strip hole outward for inserting a hook. Aft is the link ring 3. The lower end of the cross has a manual screw 6, which helps clamp anti-skid plate is a set of clamping screw plates similar to those on the tail section at the lower end of the two connecting rings of the normal anti-skid plate. This plate is required to be designed at ⅔ of the total length. On either side of the head of the anti-skid section, an additional pair of ratchet hooks corresponding to the strip holes embedded in the tail segment is provided. The present invention has a crankshaft tensioning mechanism. Eccentricity of crankshaft is 20 mm. When the crankshaft is eccentric outward, the spacing between front and rear anti-skid plates is increased by 20 mm. When the crankshaft rotates 180 degrees out of center, the spacing between front and rear anti-skid plates is reduced by 20 mm. By adjusting the crankshaft with inner or outer eccentricity, the total length of the anti-slip chain can be enlarged or reduced by 40 mm. When increasing, hook plate 4 and hook 5 with holes can be easily detached, and when shrinking, and they cannot be loosened.

The handle pulling the crankshaft. It is connected to the crankshaft in a universal joint manner. That is to say, we can turn the crankshaft 180 degrees with handle 9, and then fold the handle 9 180 degrees back to the original position. We can also use a wrench to turn the crankshaft in two consecutive 90-degree turns, folding the wrench 180 degrees in the middle, so that it will eventually return to its original position after completing the task. The important benefit of this setup is that it can overcome the issue of a small space between the tire and fender.

Handle stabilization card. It is attached to the side of the anti-skid plate. At its bottom is an elastic card, which can jam the operating handle 9 to prevent its automatic movement. In the middle is a permanent magnet, which can attach the wrench as a double insurance.

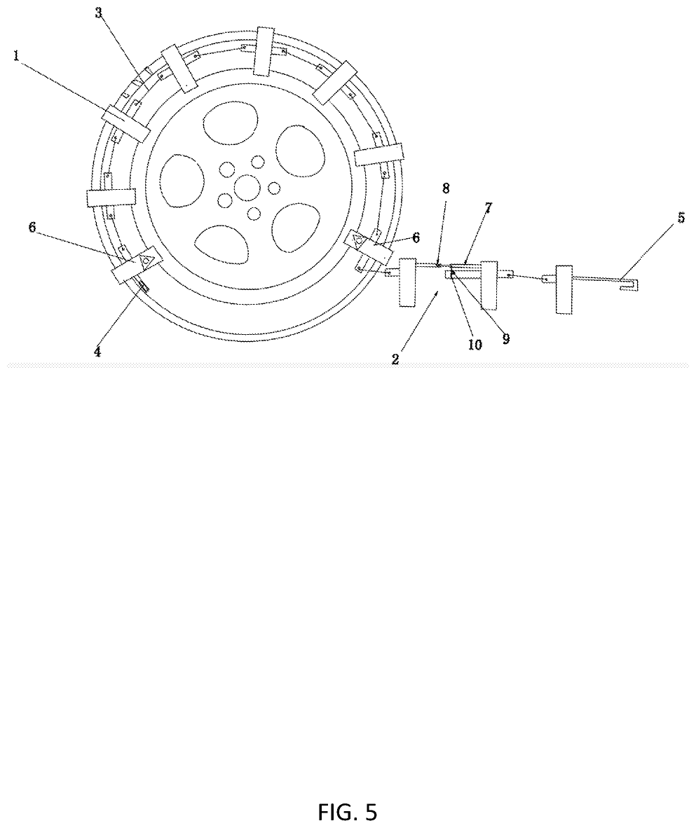

The use method of the present invention is (see FIG. 5, taking the left installation as an example, the right installation principle is the same).

One, stop the car, push the anti-skid chain directly into the car from the side, buckle the tire from top to bottom. If there is too little space between the fender and the tire and it is difficult to push in the side due to the skid block, the skid chain can be dragged along the outside diameter of the tire to cover the tire.

Two, press the tail plate of the anti-skid chain (the last U-shaped anti-skid chain 1) in the direction of 8 o'clock, and turn the manual screw 6 to clamp it to the tire.

Three, install the second U-shaped anti-skid chain 1 with manual screw 6, clamp in the same way at the position of four o'clock (The position of the manual screw is preset and should be loosened before disassembly), i.e., about ⅔ of the total length.

Four, start the car forward, rotate the tire about 180 degrees forward. Let the rest of the anti-skid chain, which is not initially fixed, rotate to the position of about 10 to 2 o'clock above the tire.

Five, insert the hook 5 on the end section of the anti-skid chain into the strip hole of the hook plate 4 with holes in the end section of the anti-skid chain. Due to the large hole and large interval, it should be easy to insert in. The head and tail sections of the anti-skid chain are symmetrical inside and outside, so the naked eyes can see that the outsider hook is embedded. The insider part, even invisible, should have been embedded also.

Six, the standby anti-skid chain is naturally in the state of “about 40 mm longer” for easy hook insertion. Pull the operating handle 9 out of the stability card 10. Covert the crank shaft to the “about 40 mm shorter” state by operating handle 9, and then reposition the handle 9. Now the head and tail of the chain are now firmly occluded. Without reverse operation, it will not be possible to loosen.

### Implementation Example 2

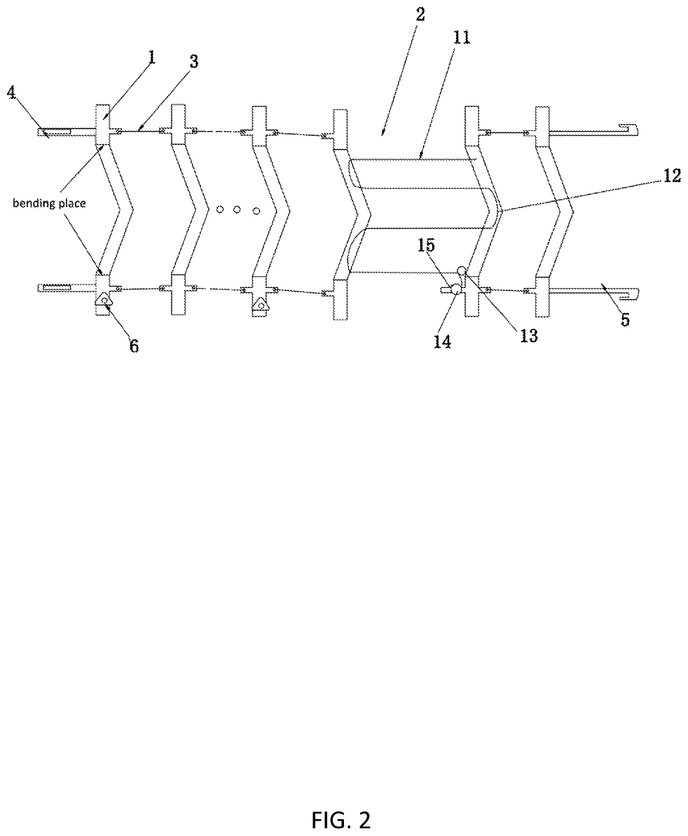

See FIG. 2.

The difference between this Example and Example 1 is that the tightening mechanism adopts the wire rope tightening mechanism. The mechanism used here is the wire rope tightening mechanism. One end of the wire rope 11 is attached to the bottom edge of a U-shaped anti-skid plate, and then enters the guide slot 12 of the adjacent U-shaped anti-skid plate and passes through the bottom edge of the two adjacent U-shaped anti-skid plate in an S-shape and then enters the guide ring 13 on a U-shaped anti-skid plate, and finally wounds on the ratchet 14. Turning the ratchet 14 can tighten the wire rope. Loosening the pawl 15 can reversely loosen the wire rope.

### Implementation Example 3

See FIGS. 3 and 4.

An external tensioning anti-skid chain for an automobile, which comprises multiple U-shaped anti-skid plates of the same structure 1 and a set of wire rope tightening mechanism 16. The two vertical sides of U-shaped anti-skid plate 1 are attached to the inside and outside of the tire. The first section (head section) and the last section (tail section) U-shaped anti-skid plates 1 are connected through the wire rope tightening mechanism 16. A manual screw plate 6 for mounting and positioning is attached to the lateral vertical side of one or two U-shaped anti-skid plates 1. The wire rope tightening mechanism 16 is composed of a wire rope 11, a ratchet wheel 14 and a ratchet claw 15. One end of the wire rope 11 is fixed on the inner bottom edge of U-shaped anti-skid plate 1. The other end is connected to the ratchet 14 by bypassing the guide slot 12 on the adjacent U-shaped anti-skid plate 1. When turning the ratchet 14 to tighten the wire rope 11 and releasing the ratchet 15, the ratchet 14 can turn in the inverse direction. The wire rope changes from tensioned to slack, and it can be taken out of the guide groove 12, so that the anti-skid chain can be removed from the tire (the manual screw plate 6 should be loosen first).

The parts not involved in the present invention can be realized by using existing technology.

1. An external tensioning anti-skid chain system for an automobile, the system comprising:
a. a tire;
b. a plurality of U-shaped anti-skid plates;
c. each U-shaped anti-skid plate comprises an inner vertical side and an outer vertical side;
d. the inner vertical side is attached to the inside of the tire and the outer vertical side is attached to the outside of the tire;
e. each U-shaped anti-skid plate further comprises a first section and a last section;
f. the first section and the last section are connected by a buckle structure;
g. a plurality of tightening mechanisms;
h. each tightening mechanism is installed between adjacent U-shaped anti-skid plates; and
i. adjacent U-shaped anti-skid plates are connected by connection rings.

2. The system of claim 1 further comprising:
a. the buckle structure comprises a hook plate with a plurality of holes connected at the inner vertical side and the outer vertical side;
b. the buckle structure further comprises a hook at the inner vertical side and a hook at the outer vertical side;
c. the hook is hooked into a hole on the hook plate; and
d. the inner vertical side and the outer vertical side are curved inward enabling the inside and the outside of the tire to be held after installation.

3. The system of claim 2 further comprising:
a. the length of the hook plate is adjustable; and
b. a thread at the root of the hook plate can be adjusted to adapt to different abrasion conditions of the tire.

4. The system of claim 1, wherein a bottom of the U-shaped anti-skid plate in contact with a ground surface has a chevron pointing character grain structure to increase pressure on an ice surface and to enhance an anti-skid effect.

5. The system of claim 1 further comprising:
a. a manual screw plate for mounting and positioning;
b. the manual screw plate is mounted to the outer vertical side of a U-shaped anti-skid plate; and
c. wherein the manual screw plate is mounted to the outer vertical side in a position corresponding to a four o'clock position or an eight o'clock position on the tire.

6. The system of claim 1 further comprising:
a. a first manual screw plate for mounting and positioning;
b. a second manual screw plate for mounting and positioning;
c. the first manual screw plate is mounted to the outer vertical side of a U-shaped anti-skid plate corresponding to a four o'clock position on the tire; and
d. the second manual screw plate is mounted to the outer vertical side of a U-shaped anti-skid plate corresponding to an eight o'clock position on the tire.

7. The system of claim 1 further comprising:
a. each tightening mechanism is a crankshaft tightening mechanism;
b. the crankshaft tightening mechanism comprises a crankshaft and an operating handle;
c. the crankshaft is configured to pivot on a mounting plate attached to a U-shaped anti-skid plate;
d. the crankshaft is configured to be inserted into a crank sleeve connected to adjacent U-shaped anti-skid plates;
e. an outer spindle of the crankshaft is connected with an operating handle; and
f. a stability card is arranged on a vertical side of a U-shaped anti-skid plate of the crankshaft.

8. The system of claim 7 further comprising:
a. the crank sleeve is connected to a U-shaped anti-skid plate through a polyurethane connector;
b. the inner vertical side and the outer vertical side are in a cruciform structure;
c. the connection rings are in a tightened position; and
d. the outer spindle of the crankshaft is flanged with the operating handle through a universal joint.

9. The system of claim 1 further comprising:
a. each tightening mechanism is a steel-wire-rope tightening mechanism;
b. the steel-wire-rope tightening mechanism comprises a wire rope, a ratchet, and a pawl;
c. a first end of the wire rope is attached to a bottom edge of a U-shaped anti-skid plate;
d. the first end of the wire rope enters a guide slot of an adjacent U-shaped anti-skid plate, passes through bottom edges of the two adjacent U-shaped anti-skid plates in an S-shape, enters a guide ring on the U-shaped anti-skid plate, and wounds on the ratchet;
e. wherein turning the ratchet can tighten the wire rope; and
f. wherein loosening the pawl can loosen the wire rope.

10. The system of claim 2 further comprising:
a. the hook plate and the hook are installed on the vertical sides of each U-shaped anti-slide plate; and
b. a mounting plate and a crank sleeve connected to a bottom edge of each U-shaped anti-slide plate.

11. An external tensioning anti-skid chain system for an automobile, the system comprising:
a. a tire;
b. a plurality of U-shaped anti-skid plates;
c. a plurality of wire rope tightening mechanisms;
d. each wire rope tightening mechanism is installed between adjacent U-shaped anti-skid plates;
e. each U-shaped anti-skid plate comprises an inner vertical side and an outer vertical side;
f. the inner vertical side is attached to the inside of the tire and the outer vertical side is attached to the outside of the tire;
g. each U-shaped anti-skid plate further comprises a first section and a last section;
h. the first section and the last section are connected by a wire rope tightening mechanism;
i. a manual screw plate for mounting and positioning;
j. the manual screw plate is connected to the outer vertical side a U-shaped anti-skid plate;
k. each wire rope tightening mechanism comprises a wire rope, a ratchet, and a pawl;
l. a first end of the wire rope is attached to a bottom edge of a U-shaped anti-skid plate;
m. a second end of the wire rope is connected to the ratchet by bypassing a guide slot on an adjacent U-shaped anti-skid plate;
n. wherein turning the ratchet can tighten the wire rope; and
o. wherein turning the ratchet in a reverse direction releases the pawl, loosens the wire rope, releases the wire rope from the guide slot, and enables removal of a U-shaped anti-skid plate from the tire.
